(19) United States
(12) Patent Application Publication
(10) Pub. No.: US 2014/0098942 A1
(43) Pub. Date: Apr. 10, 2014

(54) RADIATION GENERATING APPARATUS

(71) Applicant: CANON KABUSHIKI KAISHA, Tokyo (JP)

(72) Inventors: Satoru Omura, Chigasaki-shi (JP); Kazuhiro Matsumoto, Saitama-shi (JP)

(73) Assignee: CANON KABUSHIKI KAISHA, Tokyo (JP)

(21) Appl. No.: 14/031,227

(22) Filed: Sep. 19, 2013

(30) Foreign Application Priority Data
Oct. 5, 2012 (JP) 2012-223596

(51) Int. Cl. H05G 1/02

(52) U.S. Cl. CPC H05G 1/02
USPC 378/197

(57) ABSTRACT

A radiation generating apparatus comprising: a radiation tube configured to irradiate radiation; an boom configured to support the radiation tube; an boom supporting unit configured to support the boom; a first column linked to the boom supporting unit and formed in a vertical direction; and a second column extensibly linked to the first column, the boom comprising a first connecting unit, and the second column comprising a second connecting unit, wherein when the boom is folded to the second column upon rotation about the boom supporting unit, the first connecting unit is connected to the second connecting unit.

### BACKGROUND OF THE INVENTION

1. Field of the Invention

The present invention relates to a radiation generating apparatus.

2. Description of the Related Art

Recently, as medical X-ray imaging apparatuses, there have been widely used a movable X-ray imaging cart which performs X-ray imaging in a hospital room or operating room and an apparatus which holds an X-ray tube which irradiates X-rays and an X-ray detector which detects the X-rays transmitted through a patient by using a C-boom.

When performing X-ray imaging by using the movable X-ray imaging cart, it is necessary to use an arrangement for changing the position of an X-ray tube on a bed to place the X-ray tube above an object lying on the bed. When imaging the four limbs of the object, in particular, it is impossible to keep properly positioning an X-ray detector and an X-ray tube and to capture a proper image unless it is possible to place the X-ray tube at any position on the bed.

In addition, the movable X-ray imaging cart runs through the narrow space between beds in a hospital room and on corridors between hospital wards along which stretchers and other medical apparatuses come and go, and hence needs to be folded into a compact structure when moving. For this purpose, this apparatus needs to be configured such that the boom holding the X-ray tube can be widely spread out at the time of X-ray imaging and can be accommodated in small size at the time of movement.

In the X-ray generating apparatus disclosed in Japanese Patent Laid-Open No. 2007-185514, a link type boom which supports an X-ray tube is configured to rotate about one end of the boom from an angle vertical to the ground or an angle near it. With this operation, the boom is spread out by rotation at the time of imaging and is accommodated by the reverse operation at the time of movement.

In addition, in X-ray imaging in an orthopedic surgery or the like, a high importance is placed especially on an SID (Source Image Distance) between a focal point and an image reception plane. When performing imaging operation using a movable X-ray imaging cart, therefore, it is necessary to adjust the X-ray tube in the height direction after adjustment of the X-ray tube in the horizontal direction in order to accurately adjust the SID when setting the X-ray tube.

According to the X-ray generating apparatus disclosed in Japanese Patent Laid-Open No. 2007-185514, however, as the X-ray tube is moved in the height direction, the X-ray tube is also moved in the horizontal direction. This makes it difficult to perform proper positioning.

### SUMMARY OF THE INVENTION

In consideration of the above problem, the present invention provides a technique which can adjust the position of a radiation tube such as an X-ray tube in the height direction without changing the position in the horizontal direction when positioning the tube.

According to one aspect of the present invention, there is provided a radiation generating apparatus comprising: a radiation tube configured to irradiate radiation; an boom configured to support the radiation tube; an boom supporting unit configured to support the boom; a first column linked to the boom supporting unit and formed in a vertical direction; and a second column extensibly linked to the first column, the boom comprising a first connecting unit, and the second column comprising a second connecting unit, wherein when the boom is folded to the second column upon rotation about the boom supporting unit, the first connecting unit is connected to the second connecting unit.

Further features of the present invention will be apparent from the following description of exemplary embodiments with reference to the attached drawings.

### BRIEF DESCRIPTION OF THE DRAWINGS

FIGS. 1A and 1B are views showing the arrangement of an X-ray generating apparatus according to the first embodiment;

FIGS. 2A and 2B are views for explaining an accommodation mechanism according to the first embodiment;

FIGS. 3A and 3B are views for explaining an accommodation mechanism according to the second embodiment;

FIGS. 4A and 4B are views for explaining an accommodation mechanism according to the third embodiment;

FIGS. 5A and 5B are views showing the arrangement of a movable X-ray generating apparatus according to the fourth embodiment;

FIG. 6 is a view for explaining an extensible column according to the fourth embodiment;

FIG. 7 is a flowchart showing a procedure for processing executed by using the X-ray generating apparatus according to the fourth embodiment; and

FIGS. 8A to 8C are views for explaining a connecting mechanism for an boom and a column according to the fifth embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

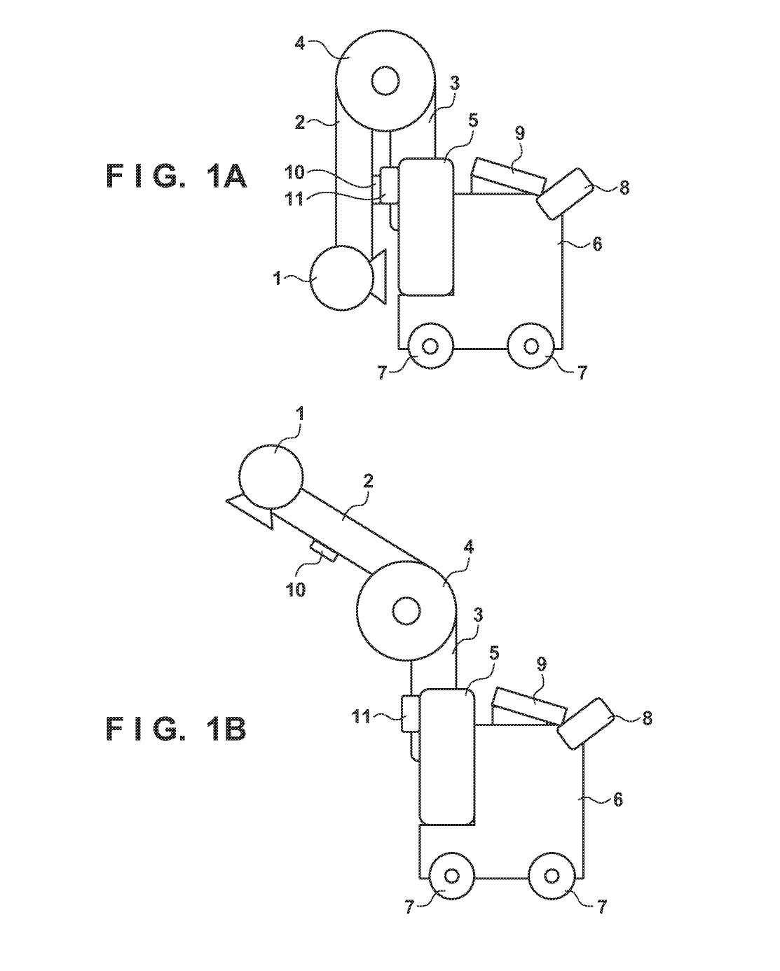

An X-ray generating apparatus will be described below as an example of a radiation generating apparatus. However, the type of radiation to be used is not limited to X-rays. It is possible to use other types of radiation such as α-rays, β-rays, and γ-rays. The arrangement of a movable X-ray generating apparatus according to the first embodiment of the present invention will be described with reference to FIGS. 1A and 1B. FIG. 1A shows the form of the X-ray generating apparatus at the time of movement. FIG. 1B shows the form of the apparatus when the boom extends at the time of imaging.

The movable X-ray generating apparatus includes an X-ray tube 1 (radiation tube), an boom 2, a first column 3, an boom supporting unit 4, a second column 5, a cart unit 6, a moving mechanism 7, a handle 8, a monitor 9, a first connecting unit 10, and a second connecting unit 11.

The X-ray tube 1 irradiates X-rays. The boom 2 supports the X-ray tube 1. The first column 3 is a column which supports the boom 2. The boom supporting unit 4 is configured to link the boom 2 to the first column 3 and allow the boom 2 to open/close with respect to the first column 3. The boom supporting unit 4 incorporates a taper pulley to keep the force applied by the operator to close/close the boom 2 constant. The force generated by the boom 2 or a spring or weight in the first column 3 is transmitted to the taper pulley through a wire.

The second column 5 is a column which allows the first column 3 to move in a direction perpendicular to the ground. That is, the first column 3 is extensible relative to the second column 5. The second column 5 incorporates an electromagnetic holder in contact with the surface of the first column 3. A portion of the first column 3 with which the electromagnetic holder comes into contact is formed from a magnetic metal. While the electromagnetic holder is energized, the extension/contraction of the first column 3 is locked. Although not shown, a signal input unit for switching the energized state of the electromagnetic holder is formed near the X-ray tube 1.

The cart unit 6 supports the second column 5. A spring or weight for making the boom 2 described above spread out may be located in the second column 5 or the cart unit 6 because power can be transmitted to the first column 3 by any combination of a pulley, a wire, a ball screw, and a gear. The moving mechanism 7 allows the cart unit 6 to move on the ground. The moving mechanism 7 can move the cart unit 6 by rotating a plurality of tires or casters while they are placed on the ground. The handle 8 is provided on the cart unit 6. When moving the apparatus, the operator operates the moving direction of the apparatus while gripping the handle 8. The monitor 9 is installed on the upper surface of the cart unit 6. The monitor 9 displays the information and position of a patient to be imaged at the time of doctor's round and a captured image. When accommodating the X-ray tube 1, the operator connects the first connecting unit 10 to the second connecting unit 11. When moving the apparatus while the boom 2 is folded toward the first column 3 or the second column 5 or not using the apparatus, the movement of the boom 2 and first column 3 is limited to prevent them from spreading out beyond a predetermined range. The first connecting unit 10 is provided on the boom 2 side, and the second connecting unit 11 is provide on the second column 5 side.

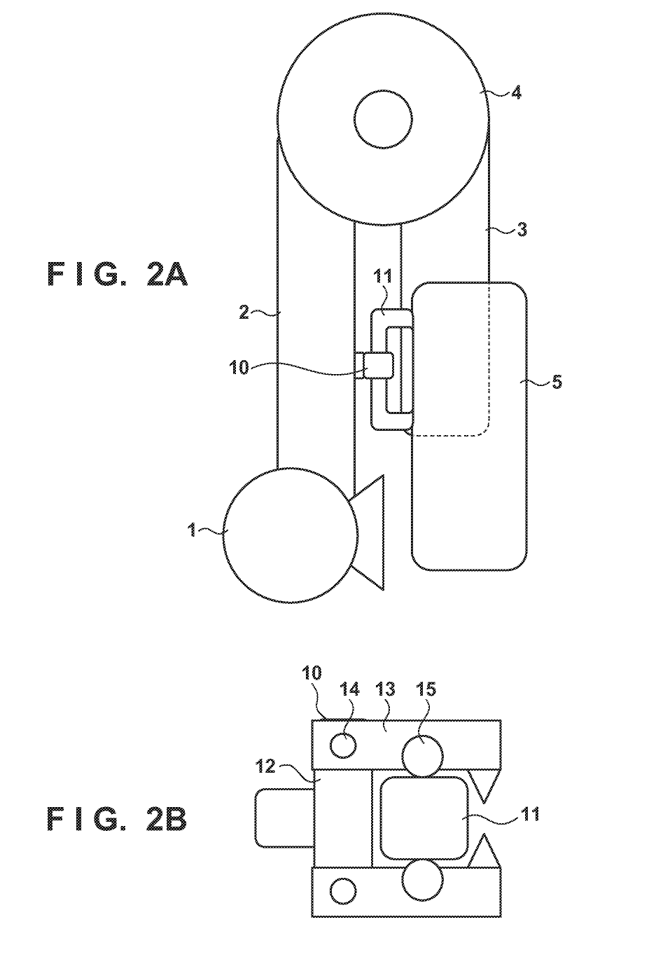

A concrete arrangement of the accommodation mechanism will be described next with reference to FIGS. 2A and 2B. FIG. 2A shows a concrete side surface shape of the accommodation mechanism. FIG. 2B shows a concrete sectional shape of the accommodation mechanism. The first connecting unit 10 on the boom side includes a base portion 12, pawl portions 13, rotating shaft portions 14, and rollers 15.

The base portion 12 is fixed to the boom 2. Each pawl portion 13 includes a projection portion on the distal end side surface. The pawl portions 13 have projections formed on the two ends of the base portion 12 to face each other. Each pawl portion 13 rotates about the corresponding rotating shaft portion 14 relative to the base portion 12. The rotating shaft portions 14 are provided with springs, which apply a force to rotate (bias) the pawl portions 13 in FIG. 2B so as to sandwich the second connecting unit 11 on the column side. Each roller 15 is provided in the pawl portion 13 so as to partly expose.

The second connecting unit 11 on the column side has a U shape. The protruding portions on the two ends of the second connecting unit 11 are fixed to a side surface of the second column 5 with screws or an adhesive. With this arrangement, folding the boom 2 to the column side will connect the first connecting units 10 on the boom side to the second connecting unit 11 so as to sandwich the second connecting unit 11 on the column side. Since the rollers 15 are in contact with the second connecting unit 11 on the column side, the first connecting units 10 on the boom side can slide/move along the second connecting unit 11 on the column side with a specific distance range. To facilitate sliding/moving, grooves for guiding the rollers 15 may further be formed on the second connecting unit 11 on the column side.

The extensible range of the first column 3 with the first connecting units 10 being connected to the second connecting unit 11 is defined by the mount position of the second connecting unit 11 on the column side and the length of the U shape of the second connecting unit 11 on the column side in the vertical direction. This limits the movement of the first column 3 so as to inhibit it from moving to the upper and lower end portions of the extensible range. Note that the shapes of the first connecting units 10 on the boom side and second connecting unit 11 on the column side may be reversed.

With the above arrangement, the operator spreads the folded boom and positions the X-ray tube relative to an imaging irradiation field in the horizontal direction. The operator then releases the extension/contraction lock of the first column by operating the signal input unit provided near the X-ray tube. This makes it possible to change the height of the X-ray tube in the vertical direction while maintaining its horizontal position. This can easily and accurately match the irradiation field with the SID at the time of X-ray imaging, thereby providing an X-ray generating apparatus which improves the operability for the operator. Note that the arrangement described in the first embodiment may be implemented in each embodiment described later.

### Second Embodiment

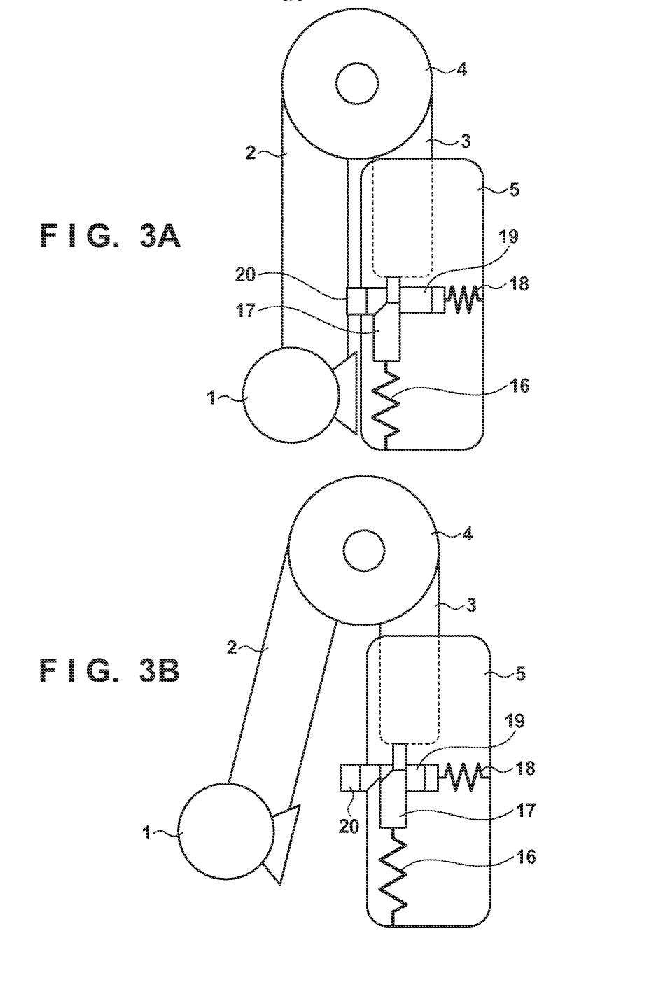

The arrangement of an accommodation mechanism according to the second embodiment of the present invention will be described with reference to FIGS. 3A and 3B. FIG. 3A shows a state in which an boom is accommodated. FIG. 3B shows a state in which the boom spreads out.

The second embodiment will exemplify an arrangement in which as the boom spreads out, the column is automatically lifted up. The same reference numerals as in the first embodiment denote the same components in the second embodiment, and a description of them will not be repeated.

A second column 5 includes a first compression spring 16, a rod 17, a second compression spring 18, a plate 19, and a contact sensor 20. One end of the first compression spring 16 is fixed to the bottom portion of the second column 5. The rod 17 is a rod for lifting up a first column 3, and has a taper portion formed on part of a side surface of the rod. The rod 17 is connected to the other end of the first compression spring 16 and is biased by the first compression spring 16 in the first direction in which the first column 3 exists. One end of the second compression spring 18 is fixed to an inner surface portion of the second column 5. The plate 19 is a plate for limiting the movable range of the rod 17, and has a hole with a taper portion formed on part of the plate. The rod 17 passes through this hole. The plate 19 is biased by the second compression spring 18 in the second direction in which the contact sensor 20 exists. The taper portions of the rod 17 and plate 19 come into contact with each other at different positions. This defines the positional relationship between the rod 17 and the plate 19.

As the operator folds an boom 2, the plate 19 is biased in a direction (a direction in which the second compression spring 18 exists) opposite to the second direction. In accordance with this operation, the taper portion of the plate 19 comes into contact with the taper portion of the rod 17 to bias the rod 17 in a direction (a direction in which the first compression spring 16 exists) opposite to the first direction, thereby lifting down the first column 3. As the boom 2 spreads out, the plate 19 is biased in the second direction. In accordance with this operation, the position of the taper portion of the plate 19 shifts from the position of the taper portion of the rod 17. As a result, they are brought into a noncontact state, and the rod 17 is biased in the first direction to be lifted up. In accordance with this operation, the first column 3 is lifted up. The contact sensor 20 detects contact or noncontact with the boom 2 to detect whether the boom 2 is spread out or folded. A control unit (not shown) which a cart unit 6 includes detects, based on the detection result obtained by the contact sensor 20, that the boom 2 is spread out, and locks the extension/contraction of the first column 3 by the electromagnetic lock of the second column 5 after the first column 3 is lifted up for a predetermined time.

With the above arrangement, the operator spreads the folded boom and positions the X-ray tube relative to an imaging irradiation field in the horizontal direction after the first column 3 is lifted up. The operator then releases the lock of the first column 3 by operating the signal input unit provided near the X-ray tube. This makes it possible to change the height of the X-ray tube in the vertical direction while maintaining its horizontal position. When the first column 3 is to be further lifted up, the length of each taper portion may be increased or a reduction gear may be provided between the rod 17 and the first column 3. This makes it possible to accommodate the boom while the first column is located at the lowest position, thereby providing an X-ray generating apparatus with good forward visibility at the time of movement.

### Third Embodiment

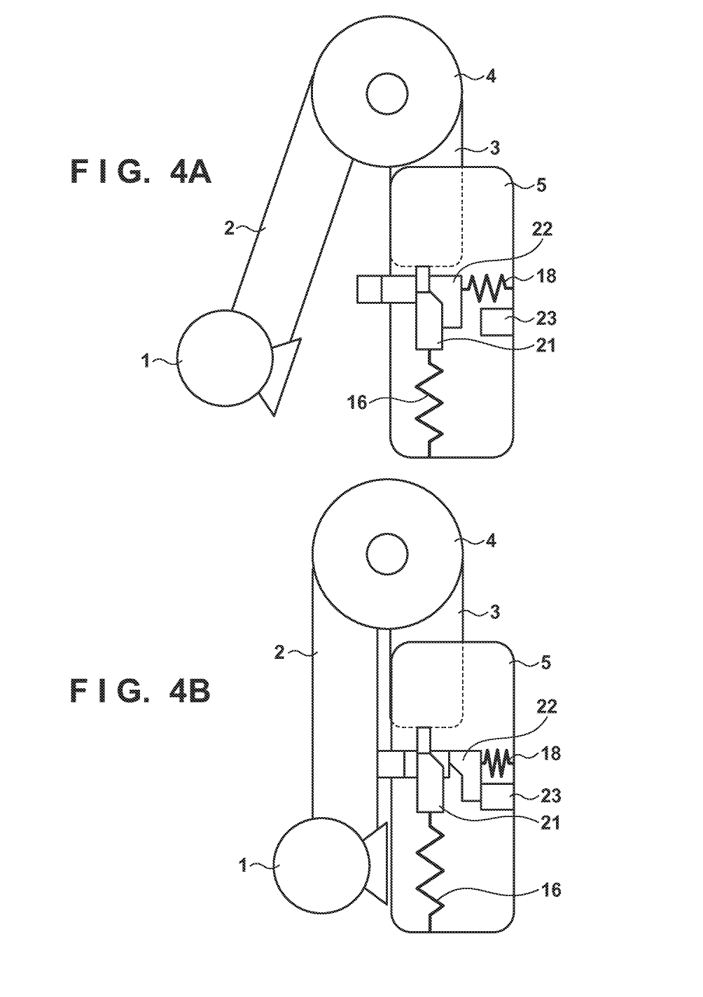

The arrangement of an accommodation mechanism according to the third embodiment of the present invention will be described with reference to FIGS. 4A and 4B. FIG. 4A shows a state in which an boom is spread out. FIG. 4B shows a state in which the boom is accommodated.

The third embodiment will exemplify an arrangement in which as the boom is folded, a column is automatically lifted down. The same reference numerals as in the first and second embodiments denote the same components in the third embodiment, and a description of them will not be repeated.

A second column 5 includes a first compression spring 16, a second compression spring 18, a rod 21, a plate 22, and a contact sensor 23. The rod 21 is a rod for lifting up a first column 3. A taper portion is formed on part of a side surface of the rod 21. The rod 21 is connected to one end of the first compression spring 16. The plate 22 is a plate for limiting the movable range of the rod 21, and is configured to partly come into contact with an boom 2. A hole having a taper portion is formed in part of the plate 22. The rod 21 passes through the hole. The taper portions of the rod 21 and plate 22 come into contact with each other at different positions. This defines the positional relationship between the rod 21 and the plate 22. The contact sensor 23 detects contact with the plate 22 to detect that the boom 2 is folded and accommodated and has come into contact with part of the plate 22 which protrudes from the second column 5.

When the boom 2 is thus folded and accommodated from the spread state, the taper portion of the plate 22 shifts and the first compression spring 16 lifts up the rod 21. The control unit of a cart unit 6 detects, based on the detection result obtained by the contact sensor 23, that the boom 2 is accommodated, and releases the extension/contraction lock of the first column 3 by using the electromagnetic lock of the second column 5. As the rod 21 is lifted up, the first column 3 is lifted up. When the bottom portion of the first column 3 exists at a position higher than the upper distal end of the rod 21 at the time of the accommodation of the boom 2, the bottom portion of the first column 3 is lifted down, under its own weight, to the distal end of the upper portion of the rod 21 after the control unit releases the extension/contraction lock of the first column 3.

With the above arrangement, accommodating the boom from the spread state will automatically adjust the first column at the accommodation position. This makes it possible to smoothly position the X-ray tube when performing next imaging operation, thereby providing an X-ray generating apparatus which has improved the operability for the operator.

### Fourth Embodiment

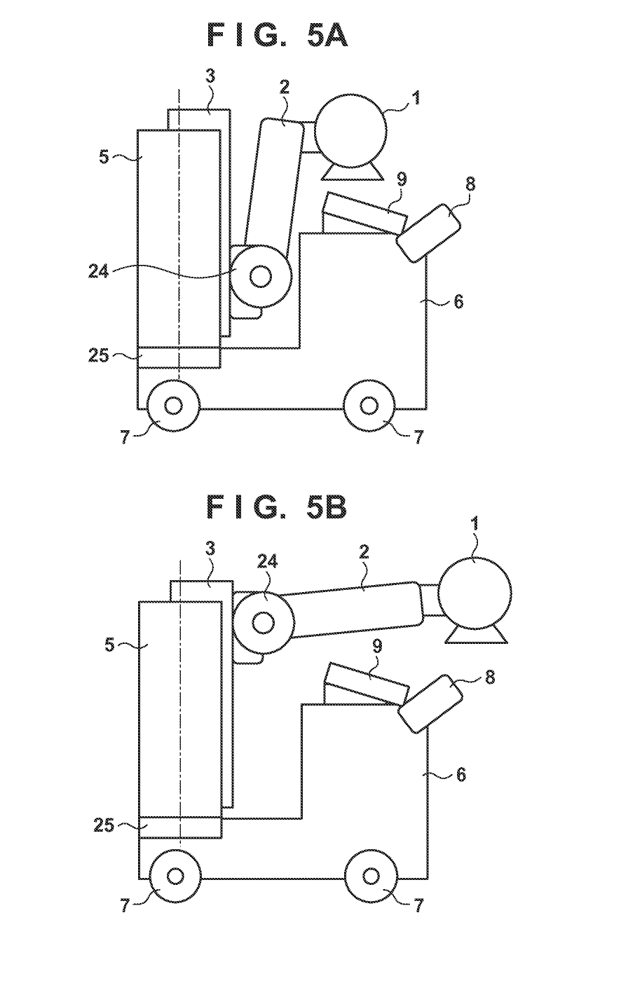

The arrangement of a movable X-ray generating apparatus according to the fourth embodiment of the present invention will be described with reference to FIGS. 5A and 5B. FIG. 5A shows a state in which the apparatus is moving. FIG. 5B shows the movable X-ray generating apparatus with its boom extending at the time of X-ray imaging. The same reference numerals as in the first to third embodiments denote the same components in the fourth embodiment, and a description of them will not be repeated.

The X-ray generating apparatus includes an X-ray tube 1, an boom 2, a first column 3, a second column 5, a cart unit 6, a moving mechanism 7, a handle 8, a monitor 9, an boom supporting unit 24, and a column rotating unit 25.

The boom supporting unit 24 is configured to link the boom 2 to the first column 3 and allow the boom 2 to open/close with respect to the first column 3. The boom supporting unit 24 is configured to be movable on the first column 3 in a direction vertical to the ground. The column rotating unit 25 links the cart unit 6 to the second column 5 and allows the second column 5 to rotate on the cart unit 6 about an axis perpendicular to the ground by using a bearing. The column rotating unit 25 is provided with a non-excitation brake to stop the rotation of the second column 5 at an arbitrary position while the non-excitation brake is energized.

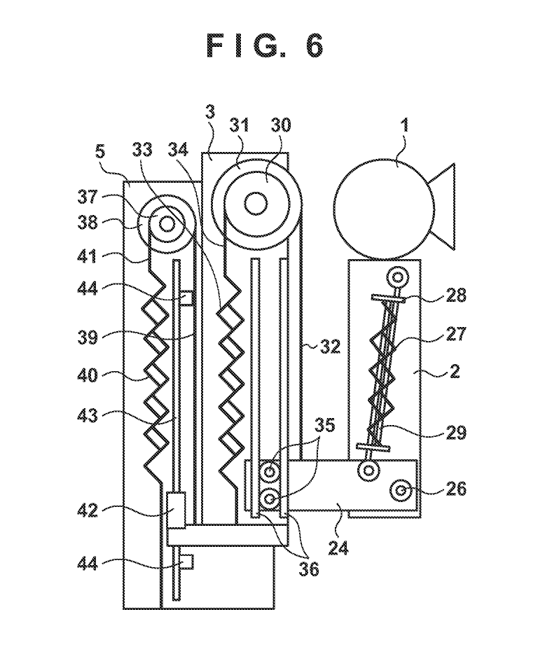

FIG. 6 shows a concrete arrangement of an extensible column. The boom 2 includes a compression spring 27, a first spring guide 28, and a second spring guide 29. The boom supporting unit 24 includes cam followers 35, and is linked to the boom 2 through a rotating unit 26. The first column 3 includes a small-diameter pulley 30, a taper pulley 31, a first wire 32, a tension spring 33, a second wire 34, and slide guide plates 36. The second column 5 includes a small-diameter pulley 37, a taper pulley 38, a third wire 39, a tension spring 40, a fourth wire 41, a linear guide 42, a linear guide rail 43, and a stopper 44. Each constituent element will be described below.

The rotating unit 26 links the boom 2 to the boom supporting unit 24. As the rotating unit 26 rotates, the boom 2 rotates relative to the boom supporting unit 24. The compression spring 27 is formed from an elastic member such as a metal spring or rubber. When the boom 2 is to be formed as a thinner member, a gas spring may be used instead of the compression spring 27. One end of the first spring guide 28 is configured to rotate on the boom supporting unit 24. One end of the second spring guide 29 is configured to rotate on the boom 2. The compression spring 27 is linked to the other end of the first spring guide 28 and the other end of the second spring guide 29.

As the operator spreads the boom 2 from the folded and accommodated state to a horizontal posture, the compression spring 27 is compressed. This produces a force to restore the boom 2 to an accommodated state, and hence the operator can switch the accommodated state of the boom 2 to the spread state or the other way around.

The small-diameter pulley 30 is provided on an upper portion in the first column 3. The taper pulley 31 is coaxial with the small-diameter pulley 30. One end of the first wire 32 is fixed to the boom supporting unit 24, and the other end is wound around the taper pulley 31. One end of the second wire 34 is connected to the tension spring 33, and the other end is wound around the small-diameter pulley 30. The taper angle of the taper pulley 31 is set to an angle that balances the weight of the members provided between the boom supporting unit 24 and the X-ray tube 1 with the force of the tension spring 33 regardless of whether the length of the tension spring 33 changes. The cam followers 35 are provided on the boom supporting unit 24.

The slide guide plates 36 are provided in the first column 3 so as to sandwich the cam followers 35. The surfaces of the slide guide plates 36 with which the cam followers 35 come into contact are preferably formed as smooth as possible to allow the cam followers 35 to slide smoothly. This makes it possible to lift up the boom 2 in a direction vertical to the ground along the first column 3 by applying predetermined small force to the members provided between the boom supporting unit 24 and the X-ray tube 1 by using the force of the tension spring 33. Providing the cam followers 35 and the slide guide plates 36 can lift up the boom supporting unit 24 on the first column 3 without changing the angle relative to the first column 3.

The small-diameter pulley 37 is provided on an upper portion in the second column 5. The taper pulley 38 is coaxial with the small-diameter pulley 37. One end of the third wire 39 is fixed to the bottom portion of the first column 3, and the other end is wound around the taper pulley 38. One end of the fourth wire 41 is connected to the tension spring 40, and the other end is wound around the small-diameter pulley 37. The taper angle of the taper pulley 38 is set to an angle that balances the weight of the members provided between the first column 3 and the X-ray tube 1 with the force of the tension spring 40 regardless of whether the length of the tension spring 40 changes. The linear guide 42 is provided on the bottom portion of the first column 3.

The linear guide rail 43 is provided in the second column 5 so as to guide the linear guide 42. This makes it possible to lift up the first column 3 by applying a predetermined small force to the members provided between the first column 3 and the X-ray tube 1 with the force of the tension spring 40. Providing the linear guide 42 and the linear guide rail 43 can lift up the first column 3 in a direction vertical to the ground along the second column 5. The stopper 44 is preferably provided on a side of the linear guide rail 43 and formed from a solenoid. Energizing the stopper 44 will make a projection appear on the linear guide rail 43 to inhibit the linear guide 42 from sliding on the linear guide rail 43. This limits the slide range of the linear guide 42 and limits the extension/contraction range of the first column 3 relative to the second column 5.

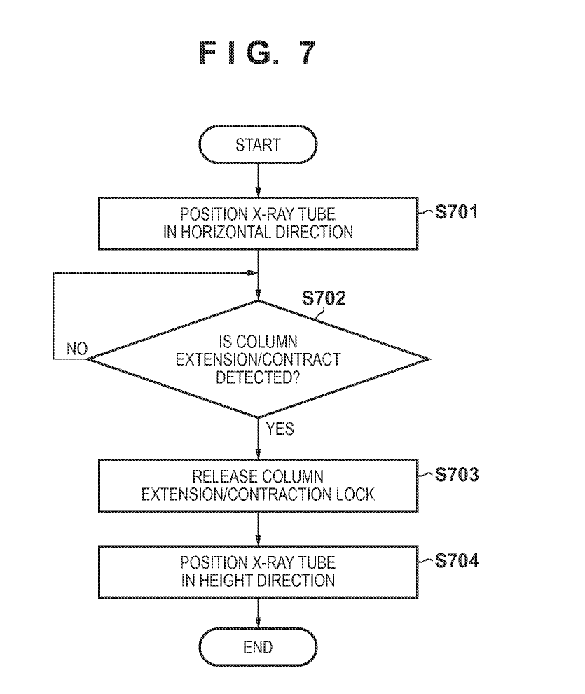

A procedure for processing executed by the X-ray generating apparatus according to the fourth embodiment of the present invention will be described below with reference to the flowchart of FIG. 7.

In step S701, the operator moves the X-ray tube 1 to position the X-ray tube 1 relative to an imaging irradiation field in the horizontal direction. In step S702, the control unit of the cart unit 6 determines whether a column extension/contraction signal from the signal input unit described in the first embodiment has been detected. The operator generates signals by using the signal input unit in accordance with the position of the boom 2 on the first column 3 and the position of the first column 3 on the second column 5. If the control unit determines that a column extension/contraction signal is detected (YES in step S702), the process advances to step S703. If the control unit determines that no column extension/contraction signal is detected (NO in step S702), the control unit waits until the detection of the above signal.

In step S703, the control unit of the cart unit 6 releases the column extension/contraction lock by switching the energization of the stopper 44 to extend the slide area of the linear guide 42. In step S704, the operator positions the X-ray tube 1 in the height direction. Thereafter, the apparatus shifts to X-ray imaging.

With the above arrangement, in X-ray imaging operation using a link boom which can move on the column in the vertical direction, it is possible to change the height of the X-ray tube while maintaining its horizontal position at any position in the movable range. This can easily and accurately match the irradiation field with the SID at the time of X-ray imaging, thereby providing an X-ray generating apparatus which improves the operability for the operator.

### Fifth Embodiment

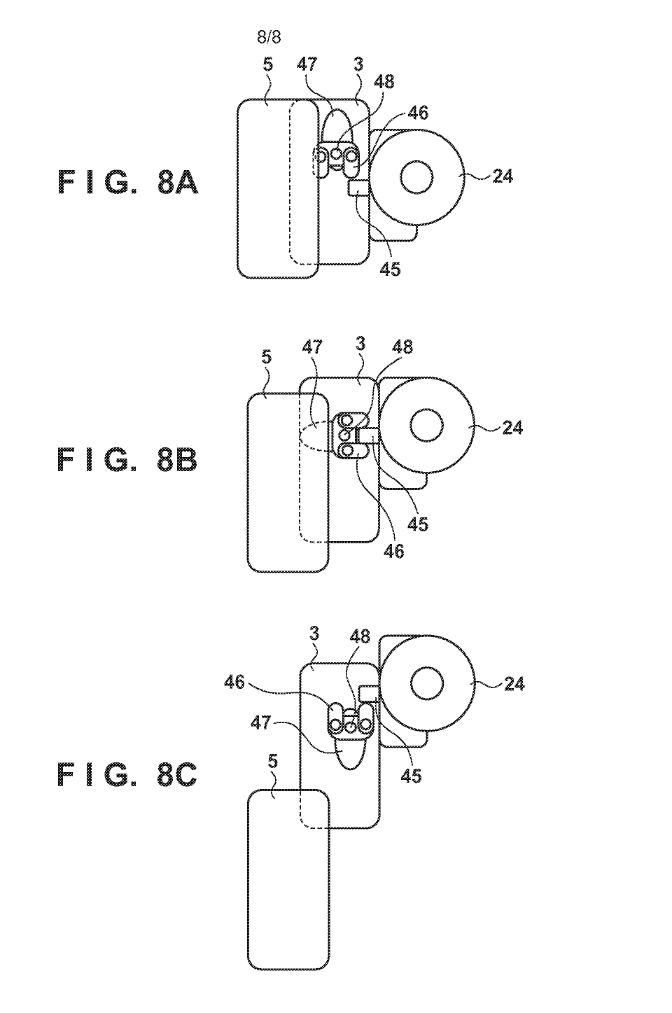

The arrangement of a connecting mechanism for an boom and a column according to the fifth embodiment of the present invention will be described with reference to FIGS. 8A to 8C. FIG. 8A shows a state in which the boom moves at a position lower than the lowest height of the first column. FIG. 8B shows a state in which the boom moves at a position higher than the lowest height of the first column. FIG. 8C shows a state in which the boom is located at the highest position.

The fifth embodiment will exemplify an arrangement which inhibits the column from moving to a position higher than the boom during extension/contraction of the column. The same reference numerals as in the first to fourth embodiments denote the same components in the fifth embodiment, and a description of them will not be repeated.

An boom supporting unit 24 includes a protruding portion 45. A first column 3 includes a hook portion 46, a cam 47, and a rotating shaft portion 48. The protruding portion 45 protrudes from the boom supporting unit 24 toward the inside of the first column 3. The protruding portion 45 moves, together with the boom supporting unit 24, in the vertical direction along the first column.

The hook portion 46, the cam 47, and the rotating shaft portion 48 are provided in the first column 3. The hook portion 46 is shaped to be hooked on the protruding portion 45 as it moves. The hook portion 46 and the cam 47 rotate about the rotating shaft portion 48. The rotating shaft portion 48 has rotational resistance due to friction, and the hook portion 46 and the cam 47 are structured not to rotate due to the self weights. The cam 47 has a portion which comes into contact with part of the first column 3 as the cam rotates. This portion is provided with a rubber member or elastic member to further add resistance to the rotation of the hook portion 46 and cam 47.

The hook portion 46, the cam 47, and the rotating shaft portion 48 are positioned such that when the protruding portion 45 hooks on the hook portion 46 and the cam 47 comes into contact with the first column 3, the highest position of the boom is equal to or higher than the highest position of the column in a contraction state. In addition, in this embodiment, the resistance against the force to move the boom supporting unit 24 on the first column 3 is configured to be smaller than the resistance against the force to move the first column 3 on a second column 5. With this arrangement, when the height position of an X-ray tube is to be changed, the vertical movement of the boom supporting unit 24 relative to the first column 3 is performed in preference to the vertical movement of the first column 3 relative to the second column 5.

With the above arrangement, when the protruding portion 45 is located at a position lower than the hook portion 46, the extensible column contracts to the highest degree. In this state, moving the boom supporting unit 24 on the first column 3 will change the height of the X-ray tube. When the protruding portion 45 hooks on the hook portion 46, the cam 47 stops the movement of the boom supporting unit 24, and the first column 3 moves on the second column 5 to change the height of an X-ray tube 1.

While the column extends to the highest degree, when the protruding portion 45 moves to a position higher than the hook portion 46, the boom supporting unit 24 moves further upward on the first column 3 to raise the X-ray tube. This inhibits the column from being located higher than the boom, and hence the operator can perform operation in consideration of only the maximum height of the boom.

This embodiment is constituted by only mechanisms. However, in order to obtain the same effect, the embodiment may provide a system which detects the height of the boom at the highest point and the height of the column at the highest point, and electrically brakes a mechanism for moving the boom and the column in the height direction when the height of the column at the highest point exceeds the height of the boom at the highest point. In addition, although the embodiment gives consideration to the highest position of the boom and the highest position of the column, the highest position of the X-ray tube may be regarded as the highest position of the boom.

With the above arrangement, the operator can easily pay attention to an object even while handling the boom and the X-ray tube. This can improve the operability for the operator and perform X-ray imaging while quickly responding to a change of the object.

Note that the above embodiments may be executed independently or in combination.

According to the present invention, when positioning a radiation tube, it is possible to adjust the position of the tube in the height direction without changing its position in the horizontal direction.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-223596 filed on Oct. 5, 2012, which is hereby incorporated by reference herein in its entirety.

What is claimed is:

1. A radiation generating apparatus comprising:
a radiation tube configured to irradiate radiation;
an boom configured to support said radiation tube;
an boom supporting unit configured to support said boom;
a first column linked to said boom supporting unit and formed in a vertical direction; and
a second column extensibly linked to said first column,
said boom comprising a first connecting unit, and
said second column comprising a second connecting unit,
wherein when said boom is folded to said second column upon rotation about said boom supporting unit, the first connecting unit is connected to the second connecting unit.

2. The apparatus according to claim 1, wherein the first connecting unit is configured to move within a specific distance range in a vertical direction relative to the second connecting unit while being connected to the second connecting unit.

3. The apparatus according to claim 1, wherein said second column comprises:
a rod configured to come into contact with said first column;
a first compression spring configured to bias said rod in a first direction in which said first column exists;
a contact sensor configured to detect, when said boom is folded to said second column upon rotation about said boom supporting unit, contact between said folded boom and said second column;
a plate linked to said contact sensor; and
a second compression spring configured to bias said plate in a second direction in which said contact sensor exists,
wherein when said plate is biased in a direction opposite to the second direction as said boom is folded, a taper portion of said plate comes into contact with a taper portion of said rod to bias said rod in a direction opposite to the first direction, and said first column is lifted down.

4. The apparatus according to claim 3, wherein when said plate is biased in the second direction as said boom spreads out, the taper portion of said plate separates from the taper portion of said rod, and said rod is biased in the first direction to lift up said first column.

5. The apparatus according to claim 1, wherein said second column comprises:
a rod configured to come into contact with said first column;
a first compression spring configured to bias said rod in a first direction in which said first column exists;
a contact sensor configured to detect, when said boom is folded to said second column upon rotation about said boom supporting unit, contact between said folded boom and said second column;
a plate configured to come into contact with said boom; and
a second compression spring configured to bias said plate in a second direction in which said boom exists,
wherein when said plate is biased in a direction opposite to the second direction as said boom is folded, a taper portion of said plate separates from a taper portion of said rod to bias said rod in the first direction, and said first column is lifted up.

6. The apparatus according to claim 5, wherein when said plate is biased in the second direction as said boom spreads out, the taper portion of said plate comes into contact with the taper portion of said rod, and said rod is biased in a direction opposite to the first direction to lift down said first column.

7. The apparatus according to claim 1, wherein said boom supporting unit is configured to move in a vertical direction along said first column.

8. The apparatus according to claim 7, further comprising a rotating unit configured to rotatably link said boom supporting unit to said boom.

9. The apparatus according to claim 8, wherein said boom comprises:
a first spring guide having one end rotatably linked to said boom supporting unit;
a second spring guide having one end rotatably linked to said boom; and
a compression spring linked to the other end of said first spring guide and the other end of said second spring guide,
wherein said compression spring extends as said boom is folded and is compressed as said boom spreads out.

10. The apparatus according to claim 1, wherein said boom supporting unit comprises a protruding portion protruding toward the inside of said first column,
said first column comprises
a hook portion configured to hook on the hook portion,
a cam linked to the hook portion, and
a rotating shaft portion configured to rotate the hook portion and the cam,
said boom supporting unit is configured to move along said first column, and
the cam comes into contact with part of said first column while the protruding portion is hooked on the hook portion upon movement of said boom supporting unit.

11. The apparatus according to claim 10, wherein a resistance against a force to move said boom supporting unit along said first column is lower than a resistance against a force to move said first column along said second column.
